(19) United States
(12) Patent Application Publication
(10) Pub. No.: US 2019/0376199 A1
(43) Pub. Date: Dec. 12, 2019

(54) RAPID TOOLING USING MELTABLE SUBSTRATE AND ELECTRODEPOSITION

(71) Applicant: The Boeing Company, Chicago, IL (US)

(72) Inventor: Thomas K. Tsotsis, Orange, CA (US)

(21) Appl. No.: 16/004,696

(22) Filed: Jun. 11, 2018

(51) Int. Cl. C25D 1/10; C25D 1/02; B64F 5/10

(52) U.S. Cl. CPC C25D 1/10; B64F 5/10; C25D 1/02

(57) ABSTRACT

Systems and methods are provided for rapidly producing complex aircraft assembly tools using a meltable substrate and electrodeposition. One embodiment is a method that includes forming a meltable substrate into a model that corresponds with a shape of the aircraft assembly tool, wherein the meltable substrate is integrated with an electrically conductive material. The method also includes electrodepositing metal onto the outer surface of the model to form a metal frame having the shape of the aircraft assembly tool, the metal frame having at least one hole. The method further includes melting the model to remove the meltable substrate and the electrically conductive material from the metal frame via the hole to form a hollow metal tool having the shape of the aircraft assembly tool.

### FIELD

The disclosure relates to the manufacture of aircraft assembly tools.

### BACKGROUND

Aircraft assembly tools are designed and manufactured for specific tasks and specific aircraft components. Construction of an aircraft assembly tool therefore often requires a high degree of precision. Even small changes to aircraft design or its components can mean that an entirely new assembly tool needs to be produced, which can cause assembly delays and increased tooling costs. Traditional tooling techniques, such as welding and milling, have long lead times for procurement and are often prohibitively difficult and expensive for making complex-shaped tools. Additive manufacturing (i.e., 3D printing) involves specialized equipment, additional post-processing steps, and can be limited in ability to produce tools with precise dimensional constraints. Casting techniques require the preparation of a blank mold and equipment capable of producing high temperatures. Therefore, a need exists for an aircraft tooling technique that is precise, inexpensive, and fast.

### SUMMARY

Embodiments described herein produce complex aircraft assembly tools using a meltable substrate and electrodeposition. A substrate that is meltable or dissolvable is shaped into the form of the desired tool. The shaped substrate is then placed in an electrodeposition bath repeatedly until a metal shell is formed around the shaped substrate. The substrate is then melted or dissolved out of the metal shell to leave a lightweight tool shape. Additional metal can be deposited onto the lightweight tool shape as needed for strengthening and forming into the desired final tool piece.

One embodiment is a system a method that includes forming a meltable substrate into a model that corresponds with a shape of the aircraft assembly tool. The model includes one or more hollow segments exposed through an outer surface of the model. The meltable substrate is integrated with an electrically conductive material. The method also includes electrodepositing metal onto the outer surface of the model to form a metal frame having the shape of the aircraft assembly tool, the metal frame having one or more holes corresponding with the one or more hollow segments of the model. The method further includes melting the model to remove the meltable substrate and the electrically conductive material from the metal frame via the one or more holes to form a hollow metal tool having the shape of the aircraft assembly tool.

In a further embodiment, the method includes forming the meltable substrate into the model via additive manufacturing, wherein the additive manufacturing forms the outer surface of the model with an amount of the electrically conductive material integrated with the meltable substrate that is sufficient for the electrodepositing of the metal. In another further embodiment, the meltable substrate is integrated with the electrically conductive material via dissolution. In one embodiment, the method includes depositing additional metal into the hollow metal tool via the one or more holes to form the aircraft assembly tool. In yet a further embodiment, the method includes forming the one or more hollow segments via additive manufacturing. In yet another embodiment, the method includes forming the one or more hollow segments via machining. In some embodiments, the meltable substrate includes wax. In still further embodiments, the electrodepositing includes repeatedly submerging the model in an electrolytic bath until an outer dimension of the metal frame matches an outer dimension of the aircraft assembly tool.

Another embodiment is a method of manufacturing an aircraft assembly tool, the method including forming a soluble substrate into a model that corresponds with a shape of the aircraft assembly tool and that includes one or more hollow segments exposed through an outer surface of the model, and wherein the soluble substrate is integrated with an electrically conductive material. The method also includes electrodepositing metal onto the outer surface of the model to form a metal frame having the shape of the aircraft assembly tool, the metal frame having one or more holes corresponding with the one or more hollow segments of the model. The method further includes dissolving the model to remove the soluble substrate and the electrically conductive material from the metal frame via the one or more holes to form a hollow metal tool having the shape of the aircraft assembly tool.

In a further embodiment, the method includes forming the soluble substrate into the model via additive manufacturing, wherein the additive manufacturing forms the outer surface of the model with an amount of the electrically conductive material integrated with the soluble substrate that is sufficient for the electrodepositing of the metal. In another further embodiment, the soluble substrate is integrated with the electrically conductive material via dissolution. In one embodiment, the method includes depositing additional metal into the hollow metal tool via the one or more holes to form the aircraft assembly tool. In yet a further embodiment, the method includes forming the one or more hollow segments via additive manufacturing. In yet another embodiment, the method includes forming the one or more hollow segments via machining. In some embodiments, the soluble substrate includes a soluble polymer. In still further embodiments, the electrodepositing includes repeatedly submerging the model in an electrolytic bath until an outer dimension of the metal frame matches an outer dimension of the aircraft assembly tool.

Yet another embodiment is a method for forming a tool. The method includes shaping a substrate into a model for the tool, integrating a conductive material with the substrate at an outer surface of the model, and electrodepositing metal onto the outer surface of the model to form a metal shell of the tool. The method also includes removing the substrate and the conductive material from a weep hole of the metal shell, and filling the metal shell with additional metal to form the tool.

In a further embodiment, the method includes removing the substrate and the conductive material from the metal shell by melting the substrate and the conductive material integrated therein through the weep hole. In another further embodiment, the method includes removing the substrate and the conductive material from the metal shell by dissolving the substrate and the conductive material integrated therein through the weep hole. In some embodiments, the method includes integrating the conductive material with the substrate by printing one or more layers forming the outer surface of the model with a combination of the substrate and the conductive material.

Another embodiment is a tool. The tool includes a body having an external surface formed by electrodepositing metal onto an outer surface of a model representing the tool, and removing the model via a hole in the external surface of the tool by melting or dissolving the model.

Other illustrative embodiments (e.g., methods and computer-readable media relating to the foregoing embodiments) may be described below. The features, functions, and advantages that have been discussed can be achieved independently in various embodiments or may be combined in yet other embodiments further details of which can be seen with reference to the following description and drawings.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a diagram of electrodeposition in an illustrative embodiment.

FIG. 2 is a flowchart illustrating a method for forming an aircraft assembly tool in an illustrative embodiment.

FIG. 3 is a flowchart illustrating a method for forming an aircraft assembly tool in another illustrative embodiment.

FIG. 4 is a flowchart illustrating a tooling method in an illustrative embodiment.

FIG. 5 is a flowchart illustrating an aircraft manufacturing and service method in an illustrative embodiment.

FIG. 6 is a block diagram of an aircraft in an illustrative embodiment.

### DESCRIPTION

The figures and the following description illustrate specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

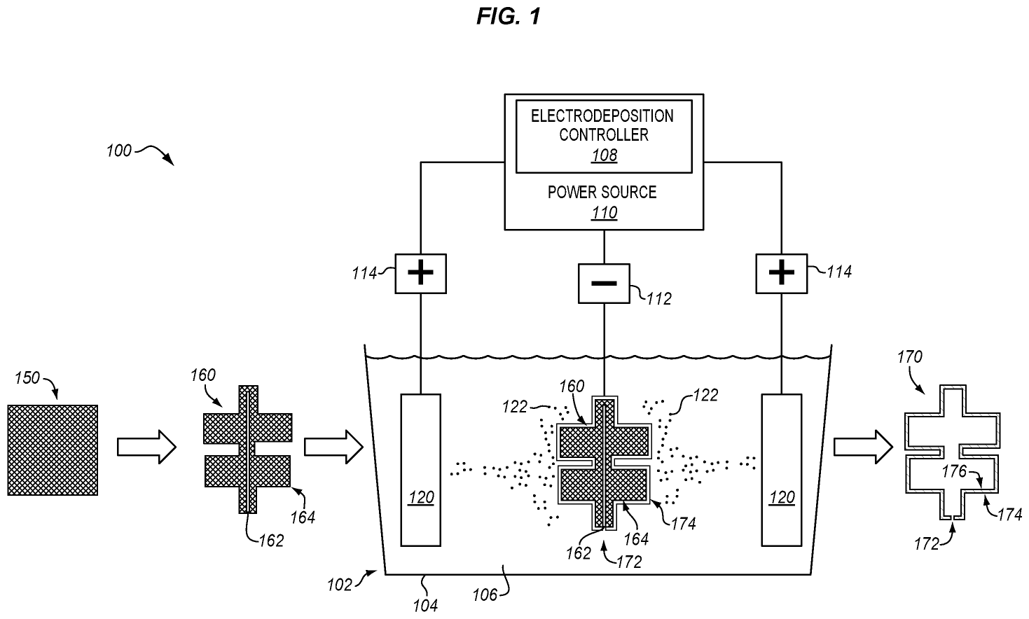

FIG. 1 is a diagram of electrodeposition 100 in an illustrative embodiment. Electrodeposition 100 generally involves the use of an electrodeposition system 102 configured to apply layer(s) of metal onto an object. The electrodeposition system 102 includes a tank 104 of liquid solution 106, a cathode 112, and one or more anodes 114. The cathode 112 is the negatively charged electrode of a power source 110 and the anodes 114 are the positively charged electrodes of the power source 110. To deposit metal onto the object, the cathode 112 is electrically coupled to the object, the anodes 114 are each electrically coupled to a metal source 120, and the object and the metal sources 120 are submerged in the liquid solution 106. With the power source 110 turned on, electric current is carried by ions 122 in the liquid solution 106, causing the ions 122 to migrate from the metal sources 120 (or anodes 114) to the object (or cathode 112) where they convert into atoms on the surface of the object, thus forming metal layer(s) on the object.

Previous electrodeposition techniques include electrodepositing metal onto a conductive or non-conductive object. A conductive object, which is typically a hard metal object, is naturally disposed for electrodeposition due to its conductivity, and electrodeposition can be used on such an object to apply additional metal layers that enhance certain properties, such as corrosion or abrasion resistance. However, a hard metal object is difficult to precisely machine into a specific shape for creation of a new tool. Prior techniques for depositing metal onto a non-conductive object involves applying a conductive coating (e.g., a thin film of silver or nickel) to the external surface of the object to promote electrodeposition. However, the applied metal coating undesirably becomes an integral part of the final electrodeposited object. Therefore, prior electrodeposition techniques are inadequate for tooling purposes such as construction of aircraft assembly tools.

Electrodeposition 100 therefore incorporates a meltable substrate 150 such as wax or another suitable material which may be easily formed or machined into a model 160 that provides the base shape for creating an aircraft assembly tool 170 via electrodeposition. Advantageously, the model 160 is formed to include one or more hollow segment(s) 162 that enable the model 160 to be removed from the final electrodeposited form of the aircraft assembly tool 170. That is, the hollow segments 162 may expose, or extend through, an outer surface 164 of the model 160. Therefore, in electrodepositing the model 160 with the electrodeposition system 102, a metal frame 174 having an inner surface 176 is formed on the outer surface 164 of the model 160, and the metal frame 174 is formed with one or more hole(s) 172 corresponding with the one or more hollow segment(s) 162. A technical benefit is thus provided in that the model 160, including the meltable substrate 150, may be melted out of the metal frame 174 via the holes 172, thereby producing the aircraft assembly tool 170 via electrodeposition without permanently integrating the model 160 with the aircraft assembly tool 170.

Additionally, the meltable substrate 150 of the model 160 is advantageously integrated with an electrically conductive material to promote electrodeposition on the model 160 while still enabling the meltable substrate 150 and the electrically conductive material to be removed from the final electrodeposited form of the aircraft assembly tool 170. In one embodiment, the meltable substrate 150 may be made electrically conductive by dissolution. In another embodiment, the meltable substrate 150 is formed into the model 160 by additive manufacturing (e.g., 3D printing), and the outer layer(s) of the model 160 (e.g., layers which form and/or are adjacent to the outer surface 164) may be printed with materials possessing sufficient conductivity to accept electrodeposition. As such, electrodeposition of the model 160 may be performed without the model 160 (and the meltable substrate 150 and electrically conductive material integrated therein) becoming integral to the final electrodeposited form of the aircraft assembly tool 170.

Since the meltable substrate 150 may include a material (e.g., wax, plastic, Styrofoam, etc.) that can be easily shaped, electrodeposition 100 may fabricate highly complex tools into precise shapes, at high rates of production, low cost, and without the use of highly specialized equipment. Moreover, since the electrodeposition system 102 enables metal bonding at near ambient temperatures, electrodeposition 100 may use low-temperature processing at each step for enhanced bonding properties as compared to traditional tooling techniques such as welding. Still further, electrodeposition 100 may produce tools to precise dimensions for strict aircraft assembly requirements without any post-fabrication machining of the tool surface.

The electrodeposition system 102 may include an electrodeposition controller 108 configured to control the power source 110 as desired to manufacture the aircraft assembly tool 170. For example, the power source 110 may include a rectifier, converter, and/or a battery capable of supplying a direct to the electrodes (e.g., the anodes 114 and the cathode 112) and electrical connections at the liquid solution 106. Thus, with the model 160 submerged in the liquid solution 106 and electrically connected to the cathode 112, the electrodeposition controller 108 may control the build-up of the metal frame 174 on the model 160 since the flow of current initiates the attraction of the ions 122 in the liquid solution 106 to the outer surface 164 of the model 160. The electrodeposition controller 108 may be implemented, for example, as custom circuitry, as a hardware processor executing programmed instructions, or some combination thereof.

Properties of the aircraft assembly tool 170, such as hardness, ductility, and strength, may be varied by controlling the deposition conditions of the electrodeposition system 102 which include, but are not limited to, the voltage level of the electric current supplied by the power source 110, the number/arrangement of the anodes 114 (or the metal sources 120), the distances between the anodes 114 (i.e., the metal sources 120) and the cathode 112 (i.e., the model 160), the type of metal of the metal sources 120, and the chemical composition and/or temperature of the liquid solution 106. Additionally, the aircraft assembly tool 170 may be an alloy deposit formed by electrodepositing two or more different metals. Typically, each of the metal sources 120 is a bar of the desired tool metal such as nickel, silver, copper, chromium, etc. The liquid solution 106, sometimes referred to as an electrolyte or an electrolytic bath, is a solution that includes dissolved metal particles of the same type of metal in the form of positively charged ions 122. Alternatively or additionally, the liquid solution 106 may include metal salts, acids, or bases.

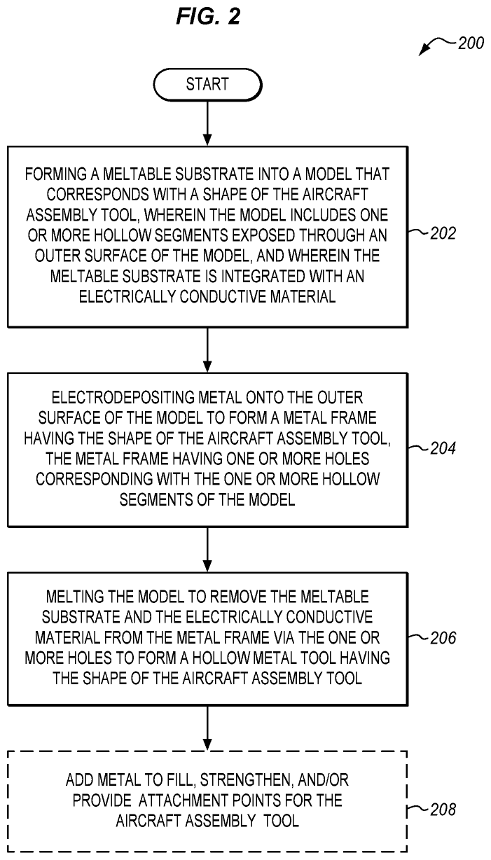

In any case, when a direct current is supplied to the anodes 114, metal atoms of the metal sources 120 oxidize and dissolve in the liquid solution 106 and the ions 122 are reduced at the metal sources 120 and deposited as atoms, layer by layer, to form the metal frame 174 on the model 160. In particular, the inner surface 176 of the metal frame 174 outlines the outer surface 164 of the model 160. The model 160 may be submerged, or repeatedly submerged (e.g., up to several tens of thousands of cycles) in the liquid solution 106 until a desired thickness of the metal frame 174 is reached. For example, the metal frame 174 may be built to a thickness sufficient to allow it to withstand a prescribed pressure. Alternatively or additionally, the metal frame 174 (and the model 160 which it surrounds) may be repeatedly submerged until an outer dimension of the metal frame 174 matches an outer dimension of the aircraft assembly tool 170. Although FIG. 1 shows a particular shape of the aircraft assembly tool 170, it will be appreciated that electrodeposition 100 may produce the aircraft assembly tool 170 having virtually any shape or structure. Similarly, the outer surface 164 of the model 160 may define any such desired shape or structure of the aircraft assembly tool 170. Furthermore, the model 160 may include alternative arrangements and configurations of the hollow segment(s) 162. Additional details of the operation of electrodeposition 100 will be discussed with regard to FIG. 2.

FIG. 2 is a flowchart illustrating a method 200 for forming an aircraft assembly tool in an illustrative embodiment. The steps of the flowcharts described herein are not all inclusive and may include other steps not shown. The steps described herein may also be performed in an alternative order.

In step 202, the meltable substrate 150 is formed into the model 160 that corresponds with a shape of the aircraft assembly tool 170. The model 160 includes one or more hollow segments 162 exposed through the outer surface 164 of the model 160. Additionally, the meltable substrate 150 is integrated with an electrically conductive material. In one embodiment, the meltable substrate 150 is formed into the model 160 via additive manufacturing (i.e., 3D printing), wherein the additive manufacturing forms the outer surface 164 of the model 160 with an amount of the electrically conductive material integrated with the meltable substrate 150 that is sufficient to promote electrodeposition. In one embodiment, the amount of electrically conductive material integrated with the meltable substrate 150 achieves a surface resistivity of less than approximately 10⁶Ω/□ (ohms per square) to promote electrodeposition. In another embodiment, the meltable substrate 150 is integrated with the electrically conductive material via dissolution. Examples of electrically conductive material include bronze, iron, cobalt nickel, gold, and copper, among other metals.

In general, the model 160 is shaped into the desired shape of the aircraft assembly tool 170 but with slightly smaller dimensions than that of the desired dimension of the aircraft assembly tool 170. In some embodiments, the hollow segments 162 may be formed via machining. In other embodiments, the hollow segments 162 may be formed via additive manufacturing. At least one of the hollow segments 162 may extend entirely through the model 160 from one side of the model 160 through to an opposite side of the model 160, thus creating two openings in the outer surface 164 of the model 160 on opposite sides. Alternatively, at least one of the hollow segments 162 may extend through the body of the model 160 with a single opening in the outer surface 164 of the model 160.

In step 204, metal is electrodeposited on the outer surface 164 of the model 160 to form the metal frame 174 having the shape of the aircraft assembly tool 170, the metal frame 174 having the holes 172 corresponding with the hollow segments 162 of the model 160. That is, during electrodeposition of the model 160 using the electrodeposition system 102, voids in the model 160 created by the hollow segments 162 prevents metal from forming at locations where the hollow segments 162 open through the outer surface 164. The hollow segments 162 therefore create the holes 172 in the metal frame 174.

In step 206, the model 160 is melted to remove the meltable substrate 150 and the electrically conductive material from the metal frame 174 via the holes 172 to form a hollow metal tool having the shape of the aircraft assembly tool 170. That is, depending on the desired function of the aircraft assembly tool 170, the metal frame 174 may, after the electrodeposition step is complete, represent the final form of the aircraft assembly tool 170 or represent the outer shell of the aircraft assembly tool 170. In the case that the metal frame 174 represents just the outer shell of the aircraft assembly tool 170, the method 200 may optionally include step 208 which includes adding metal to fill, strengthen, and/or provide attachment points for the metal frame 174 to form or finalize the aircraft assembly tool 170. For example, step 208 may include depositing additional metal into one or more of the holes 172 of the metal frame 174 to form the aircraft assembly tool 170. In any case, since the outer surface and dimension of the aircraft assembly tool 170 is precisely formed via the electrodeposition process, no post-fabrication machining of the aircraft assembly tool 170 is required.

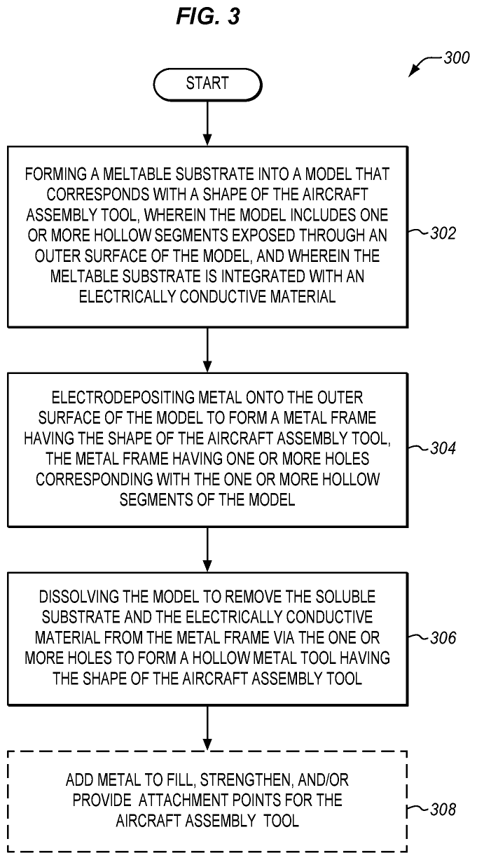

FIG. 3 is a flowchart illustrating a method 300 for forming an aircraft assembly tool in another illustrative embodiment. In this embodiment, the substrate used to form the model 160 is a dissolvable substrate. Examples of the soluble substrate include, but are not limited to, soluble polymers such as polystyrene (e.g., soluble in ketones such as acetone), etc.

In step 302, the soluble substrate is formed into the model 160 that corresponds with a shape of the aircraft assembly tool 170. The model 160 includes one or more hollow segments 162 exposed through the outer surface 164 of the model 160. Additionally, the soluble substrate is integrated with an electrically conductive material. In one embodiment, the soluble substrate is formed into the model 160 via additive manufacturing (i.e., 3D printing), wherein the additive manufacturing forms the outer surface 164 of the model 160 with an amount of the electrically conductive material integrated with the soluble substrate that is sufficient to promote electrodeposition. In another embodiment, the soluble substrate is integrated with the electrically conductive material via dissolution.

In step 304, metal is electrodeposited on the outer surface 164 of the model 160 to form the metal frame 174 having the shape of the aircraft assembly tool 170, the metal frame 174 having the holes 172 corresponding with the hollow segments 162 of the model 160. In step 306, the model 160 is dissolved to remove the soluble substrate and the electrically conductive material from the metal frame 174 via the holes 172 to form a hollow metal tool having the shape of the aircraft assembly tool 170. Optionally, in step 308, metal may be added to fill, strengthen, and/or provide attachment points for the metal frame 174 to form or finalize the aircraft assembly tool 170.

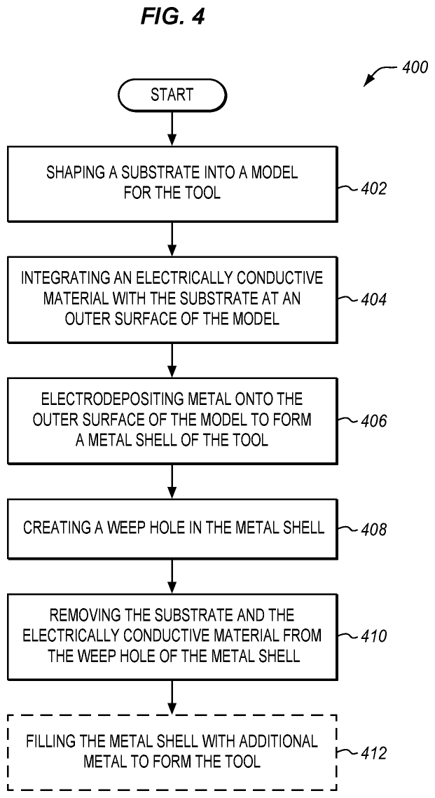

FIG. 4 is a flowchart illustrating a tooling method 400 in an illustrative embodiment. In step 402, the substrate is shaped into a model for the tool. The substrate may be any suitable material configured to melt at relatively low temperatures. Alternatively or additionally, the substrate may be any suitable material configured to dissolve. In some embodiments, step 402 may include lost-wax casting with machining to shape the model into a form that delineates the external shape of the desired tool.

In step 404, an electrically conductive material is integrated with the substrate at an outer surface of the model. In some embodiments, integrating the conductive material with the substrate may be performed by printing (e.g., with a 3D printer) one or more layers forming the outer surface of the model with a combination of the substrate and the conductive material.

In step 406, metal is electrodeposited onto the outer surface of the model to form a metal shell of the tool. In step 408, a weep hole is created in the metal shell. The weep hole may be created by forming an opening in the outer surface of the model prior to electrodeposition for creation of the weep hole during electrodeposition. Alternatively or additionally, the weep hole may be created by placing a non-conductive object on and/or through the outer surface of the model during electrodeposition of the model. The non-conductive object may be removed subsequent to electrodeposition. Alternatively or additionally, the weep hole may be created by drilling or puncturing the metal shell after electrodeposition is complete or has at least partially formed the metal shell. Alternatively or additionally, a base mold substrate may include an agglomeration of conductive and non-conductive elements with the non-conductive parts located to line up with desired hole locations. As such, local passivation may prevent coating of metal during electrodeposition to allow for melting or dissolution.

In step 410, the substrate and the electrically conductive material is removed from the weep hole of the metal shell. The substrate and the electrically conductive material may be removed from the metal shell by melting the substrate and the conductive material integrated therein through the weep hole. Alternatively or additionally, the substrate and the electrically conductive material may be removed from the metal shell by dissolving the substrate and the conductive material integrated therein through the weep hole. Optionally, in step 412, the metal shell may be filled with additional metal to form the tool.

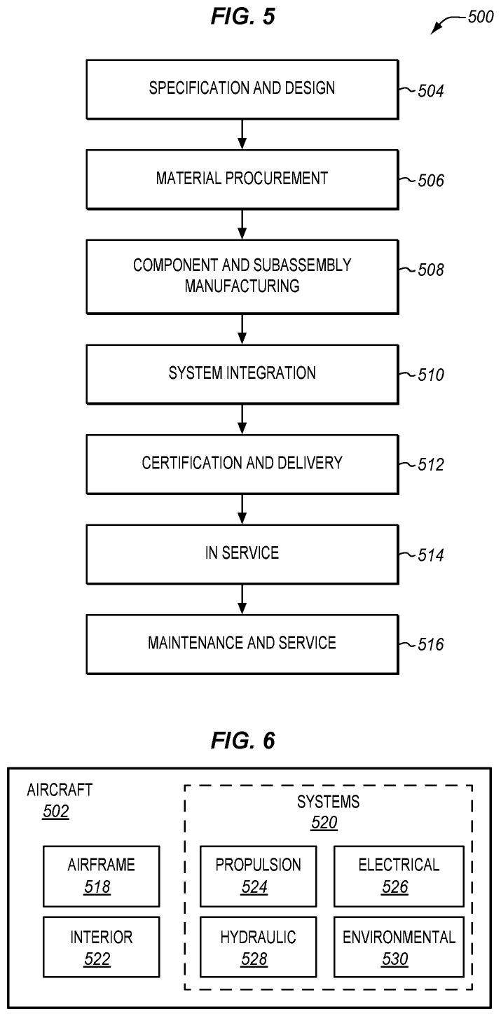

FIG. 5 is a flowchart illustrating an aircraft manufacturing and service method 500 in an illustrative embodiment. FIG. 6 is a block diagram of an aircraft 502 in an illustrative embodiment. Embodiments of the disclosure may be described in the context of an aircraft manufacturing and service method 500 as shown in FIG. 5 and an aircraft 502 as shown in FIG. 6. During pre-production, illustrative method 500 may include specification and design 504 of the aircraft 502 and material procurement 506. During production, component and subassembly manufacturing 508 and system integration 510 of the aircraft 502 takes place. Thereafter, the aircraft 502 may go through certification and delivery 512 in order to be placed in service 514. While in service by a customer, the aircraft 502 is scheduled for routine maintenance and service 516 (which may also include modification, reconfiguration, refurbishment, and so on). Apparatus and methods embodied herein may be employed during any one or more suitable stages of the production and service method 500 (e.g., specification and design 504, material procurement 506, component and subassembly manufacturing 508, system integration 510, certification and delivery 512, service 514, maintenance and service 516) and/or any suitable component of aircraft 502 (e.g., airframe 518, systems 520, interior 522, propulsion 524, electrical 526, hydraulic 528, environmental 530).

Each of the processes of method 500 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 6, the aircraft 502 produced by illustrative method 500 may include an airframe 518 with a plurality of systems 520 and an interior 522. Examples of high-level systems 520 include one or more of a propulsion system 524, an electrical system 526, a hydraulic system 528, and an environmental system 530. Any number of other systems may be included. Although an aerospace example is shown, the principles of the invention may be applied to other industries, such as the automotive industry.

As already mentioned above, apparatus and methods embodied herein may be employed during any one or more of the stages of the production and service method 500. For example, components or subassemblies corresponding to production stage 508 may be fabricated or manufactured in a manner similar to components or subassemblies produced while the aircraft 502 is in service. Also, one or more apparatus embodiments, method embodiments, or a combination thereof may be utilized during the production stages 508 and 510, for example, by substantially expediting assembly of or reducing the cost of an aircraft 502. Similarly, one or more of apparatus embodiments, method embodiments, or a combination thereof may be utilized while the aircraft 502 is in service, for example and without limitation, to maintenance and service 516. For example, the techniques and systems described herein may be used for steps 506, 508, 510, 514, and/or 516, and/or may be used for airframe 518 and/or interior 522. These techniques and systems may even be utilized for systems 520, including for example propulsion 524, electrical 526, hydraulic 528, and/or environmental 530.

Any of the various control elements (e.g., electrical or electronic components) shown in the figures or described herein may be implemented as hardware, a processor implementing software, a processor implementing firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, a control element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments are described herein, the scope of the disclosure is not limited to those specific embodiments. The scope of the disclosure is defined by the following claims and any equivalents thereof.

What is claimed is:

1. A method of manufacturing an aircraft assembly tool, the method comprising:
forming a meltable substrate into a model that corresponds with a shape of the aircraft assembly tool and that includes one or more hollow segments exposed through an outer surface of the model, and wherein the meltable substrate is integrated with an electrically conductive material;
electrodepositing metal onto the outer surface of the model to form a metal frame having the shape of the aircraft assembly tool, the metal frame having one or more holes corresponding with the one or more hollow segments of the model; and
melting the model to remove the meltable substrate and the electrically conductive material from the metal frame via the one or more holes to form a hollow metal tool having the shape of the aircraft assembly tool.

2. The method of claim 1 further comprising:
forming the meltable substrate into the model via additive manufacturing, wherein the additive manufacturing forms the outer surface of the model with an amount of the electrically conductive material integrated with the meltable substrate that is sufficient for the electrodepositing of the metal.

3. The method of claim 1 wherein:
the meltable substrate is integrated with the electrically conductive material via dissolution.

4. The method of claim 1 further comprising:
depositing additional metal into the hollow metal tool via the one or more holes to form the aircraft assembly tool.

5. The method of claim 1 further comprising:
forming the one or more hollow segments via additive manufacturing.

6. The method of claim 1 further comprising:
forming the one or more hollow segments via machining.

7. The method of claim 1 wherein:
the meltable substrate includes wax.

8. The method of claim 1 wherein:
the electrodepositing includes repeatedly submerging the model in an electrolytic bath until an outer dimension of the metal frame matches an outer dimension of the aircraft assembly tool.

9. A method of manufacturing an aircraft assembly tool, the method comprising:
forming a soluble substrate into a model that corresponds with a shape of the aircraft assembly tool and that includes one or more hollow segments exposed through an outer surface of the model, and wherein the soluble substrate is integrated with an electrically conductive material;
electrodepositing metal onto the outer surface of the model to form a metal frame having the shape of the aircraft assembly tool, the metal frame having one or more holes corresponding with the one or more hollow segments of the model; and
dissolving the model to remove the soluble substrate and the electrically conductive material from the metal frame via the one or more holes to form a hollow metal tool having the shape of the aircraft assembly tool.

10. The method of claim 9 further comprising:
forming the soluble substrate into the model via additive manufacturing, wherein the additive manufacturing forms the outer surface of the model with an amount of the electrically conductive material integrated with the soluble substrate that is sufficient for the electrodepositing of the metal.

11. The method of claim 9 wherein:
the soluble substrate is integrated with the electrically conductive material via dissolution.

12. The method of claim 9 further comprising:
depositing additional metal into the hollow metal tool via the one or more holes to form the aircraft assembly tool.

13. The method of claim 9 further comprising:
forming the one or more hollow segments via additive manufacturing.

14. The method of claim 9 further comprising:
forming the one or more hollow segments via machining.

15. The method of claim 9 wherein:
the soluble substrate includes a soluble polymer.

16. The method of claim 9 wherein:
the electrodepositing includes repeatedly submerging the model in an electrolytic bath until an outer dimension of the metal frame matches an outer dimension of the aircraft assembly tool.

17. A method for forming a tool comprising:
shaping a substrate into a model for the tool;
integrating a conductive material with the substrate at an outer surface of the model;
electrodepositing metal onto the outer surface of the model to form a metal shell of the tool;
removing the substrate and the conductive material from a weep hole of the metal shell; and
filling the metal shell with additional metal to form the tool.

18. The method of claim 17 further comprising:
removing the substrate and the conductive material from the metal shell by melting the substrate and the conductive material integrated therein through the weep hole.

19. The method of claim 17 further comprising:
removing the substrate and the conductive material from the metal shell by dissolving the substrate and the conductive material integrated therein through the weep hole.

20. The method of claim 17 further comprising:
integrating the conductive material with the substrate by printing one or more layers forming the outer surface of the model with a combination of the substrate and the conductive material.
